(19) United States
(12) Patent Application Publication
(10) Pub. No.: US 2005/0194083 A1
(43) Pub. Date: Sep. 8, 2005

(54) System for labeling refrigerant storage tanks

(76) Inventors: Steven Barnes, Nashville, TN (US); R. Theodore Atwood, Nashville, TN (US)

Correspondence Address: DEVINE, MILLIMET & BRANCH, P.A., 111 AMHERST STREET, BOX 719, MANCHESTER, NH, 03105, US

(21) Appl. No.: 11/047,517

(22) Filed: Jan. 31, 2005

Related U.S. Application Data
(63) Continuation-in-part of application No. 09/992,958, filed on Nov. 26, 2001, now abandoned.
(60) Provisional application No. 60/252,602, filed on Nov. 24, 2000.

(51) Int. Cl. B32B 31/00; F25B 45/00

(52) U.S. Cl. 156/84

(57) ABSTRACT

A refrigerant storage tank labeling system having a removable labeling apparatus. The system includes a refrigerant storage tank and a sleeve. The sleeve has a tubular shape and a predetermined size. The sleeve is in removable fitting relation at least partially about the circumference of the tank.

### CROSS-REFERENCE TO RELATED APPLICATIONS

The present application is a Continuation-In-Part of U.S. patent application Ser. No. 09/992,958 filed Nov. 26, 2001 which claims priority based on Provisional Application Ser. No. 60/252,602 filed Nov. 24, 2000 which is incorporated herein by reference.

### TECHNICAL FIELD

The present invention relates to the field of refrigerant storage tank labeling systems and more particularly to a system for labeling refrigerant storage tanks.

### BACKGROUND INFORMATION

Refrigerant storage tanks can be filled with any number of gasses or liquids. Many of these substances are harmful to animals and the environment. There is currently no standard color or shape of refrigerant storage tanks that impart the substance contained inside.

Thus, it is imperative to label the storage tank and identify its contents. However, any given storage tank can contain a number of different substances throughout its lifetime. Therefore, a labeling system capable of easy removal is imperative to avoid confusion and potentially deadly hazards.

Accordingly, there is a need for a removable refrigerant tank labeling system capable of modifications and that imparts to the user the exact contents of the refrigerant storage tank.

### SUMMARY

In accordance with one aspect of the present invention, a refrigerant storage tank labeling system having a removable labeling apparatus. The system includes a refrigerant storage tank and a sleeve. The sleeve has a tubular shape and a predetermined size. The sleeve is in removable fitting relation at least partially about the circumference of the tank.

Some embodiments of this aspect of the invention include one or more of the following. Where the sleeve is made of Linear Low Density Polyethylene, where the sleeve further includes at least one writeable portion having a predetermined size and where the sleeve includes a bar code.

In accordance with another aspect of the present invention, a refrigerant storage tank labeling system having a removable labeling apparatus. The system includes a refrigerant storage tank and a sleeve. The sleeve is made of Linear Low Density Polyethylene and has a tubular shape and a predetermined size. The sleeve is in removable fitting relation at least partially about the circumference of the tank.

Some embodiments of the present invention include where the sleeve further includes at least one writeable portion having a predetermined size and where the sleeve further includes a bar code.

In accordance with another aspect of the present invention, a refrigerant storage tank labeling system having a removable labeling apparatus. The system includes a refrigerant storage tank and a sleeve. The sleeve has an elongated shape and a predetermined size. The sleeve wraps around the tank and is attached to itself whereby the sleeve forms a tubular shape and is in removable fitting relation at least partially about circumference of the tank.

Some embodiments of the present invention include where the sleeve further includes at least one writeable portion having a predetermined size and where the sleeve further includes a bar code.

These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

These and other features and advantages of the present invention will be better understood by reading the following detailed description, taken together with the drawings wherein:

FIG. 1 is a front view of the system according to one embodiment of the present invention;

FIG. 2 is a front view of the sleeve according to one embodiment of the present invention; and

FIG. 3 is a front view of an alternate embodiment of the sleeve according to the present invention.

### DETAILED DESCRIPTION OF THE PREFERRED EMBODIMENTS

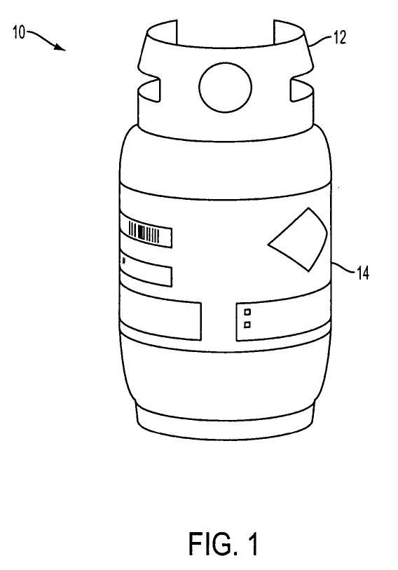

Referring to FIG. 1, a front view of the refrigerant labeling system 10 is shown. The system 10 includes a refrigerant tank 12 and a sleeve 14. The refrigerant tank 12 can be any size or shape and the sleeve 14 has a shape that is complementary to the tank 12. The refrigerant storage tank 12 is any refrigerant storage tank known in the art.

In the preferred embodiment, the sleeve 14 is tubular and is made from Linear Low Density Polyethylene (“LLDPE”). The sleeve 14 fits tightly around at least part of the refrigerant tank 12. The sleeve 14 maintains its position on the tank 14 because it fits tightly about the tank 12. The sleeve 14 is not glued onto the tank 12 or otherwise permanently attached.

Although in the preferred embodiment, the sleeve 14 covers only the center of the tank 12, in other embodiments, the sleeve 14 covers more of the tank 12. The invention contemplates where the sleeve 12 covers any portion of the tank 12 as long as it covers some portion of the tank.

The sleeve 14 is placed onto the tank 12 by opening the sleeve 14 such that the tubular structure is apparent, then either slipping the sleeve 14 over the top of the tank 12 or up from the bottom of the tank 12. In the preferred embodiment, the sleeve 14 is dimensioned such that it will fit very tightly over the tank 12. Once the sleeve 14 is placed onto the tank 12, it will remain in position until a user removes the sleeve 14.

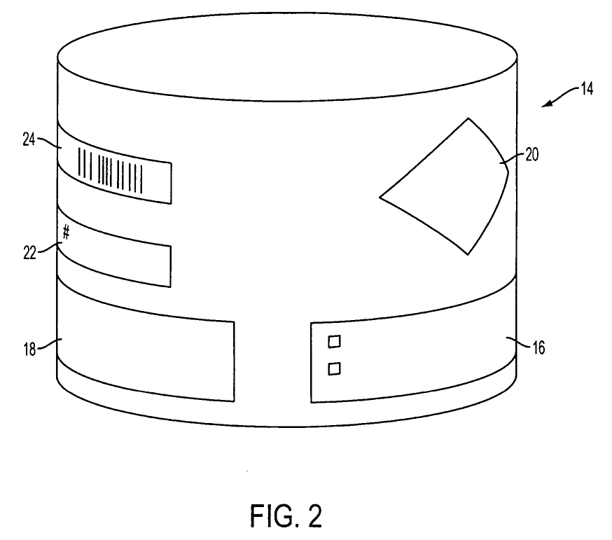

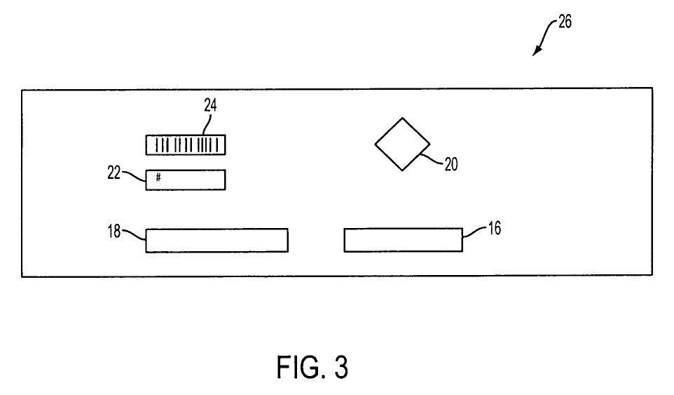

Referring next to FIG. 2, the sleeve 14 is tubular. In the preferred embodiment, the sleeve 14 is one continuous tube, i.e., there is no seem. This design makes the sleeve 14 very strong and allows the sleeve 14 to be placed onto the tank in the manner described above. Referring next to FIG. 3, an alternate embodiment of the sleeve 26 is shown. In this embodiment, the sleeve 26 is not one continuous tube, but rather, a sheet that is wrapped around a tank, wrapped over itself at least partially, and then fastened together. Thus, two ends of the sleeve 26 attach to form the tubular structure. The sleeve does not attach to the tank. The two sides of the sleeve are attached either by an adhesive being located on the sleeve itself and pressure sensitive, or an adhesive having an adhesive protective sheet, and the protective sheet being removed, allows for adhesion of the two sides. In other embodiments, any method known in the art of adhering or attaching to sides of LLDPE can be used. This creates the same effect as the tubular sleeve shown in FIG. 2, however, the sleeve 26 requires the additional step of adhering or fastening the sheet together. In the preferred embodiment, shown in FIG. 2, fastening, adhering nor attaching of any kind is required. In the preferred embodiment shown in FIG. 2, the sleeve 14 is pulled onto the tank and remains there without any additional user intervention.

Still referring to FIGS. 2 and 3, the sleeve 14, 26 is placed onto the tank and maintains its position on the tank. Thus, the sleeve 14, 26 does not require any additional attachment to the tank. Rather, the dimensions and the material of the sleeve 14, 26 inherently allow the sleeve 14, 26 to maintain its position on the tank.

Still referring to FIGS. 2 and 3, the sleeve 14 can be placed onto a refrigerant tank at any time. However, for safety reasons, it is most desirous to place the sleeve 14 onto the refrigerant tank while the tank is empty and before the refrigerant is added. Thus, to label the refrigerant tank with the intended contents prior to the contents being added.

Still referring to both FIGS. 2 and 3, the sleeve 14, 26 has at least one writeable portion of a predetermined size. In the preferred embodiment, the sleeve 14, 26 has at least two writable portions 16, 18. These areas allow the easy adhesion of typical inks used in the art. The writeable portions 16, 18 can be used to place any indicia. In the preferred embodiment, the writeable portions 16, 18 specifically queries the user to include information regarding the downstream user or “customer”. Additionally, typical or commonly used refrigerants are pre-printed on the writable portion having a check box directly next to the refrigerant. This allows for the user to simply check the appropriate box to indicate the contents of the tank.

The preferred embodiment additionally includes writeable portion 22, pre-printed with a “#” sign. This area is intended to include a number, which will be written by a user.

In the preferred embodiment, the sleeve 14, 26 includes a bar code area 24. This is for electronic identification of the tank system. The bar code used can be any of those known and used in the art. Also included in the preferred embodiment is a standard chemical hazard indication 20. Using the standard signage known and used in the art, this will indicate to the handler whether the contents of the tank are, for example, flammable, non-flammable, hazardous, non-hazardous, or any other indication known and used in the art.

In practice, the present system is used for labeling the refrigerant storage tank with information necessary for the safe handling and identification of the tank. Once the tank is emptied, the sleeve is easily removed and a new sleeve is introduced to the system. This allows for an easy change of the refrigerant contents inside the tank and ensures proper labeling of this change. Additionally, since the sleeve does not permanently attach to the tank, the sleeve is able to be completely removed, thus leaving no chance of incorrect or obsolete refrigerant contents information on the tank.

Although certain indicia has been described as being included on the sleeve, the invention is not limited to this indicia. Any indicia useful and deemed necessary or useful by any user can be included on the sleeve of the invention.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

1. A refrigerant storage tank labeling system having a removable labeling apparatus, said system comprising:
a refrigerant storage tank; and
a sleeve, said sleeve having a tubular shape and a predetermined size wherein said sleeve is in removable fitting relation at least partially about circumference of said tank.

2. The system of claim 1 wherein said sleeve is made of Linear Low Density Polyethylene.

3. The system of claim 1 wherein said sleeve further comprising at least one writeable portion having a predetermined size.

4. The system of claim 1 wherein said sleeve further comprising a bar code.

5. A refrigerant storage tank labeling system having a removable labeling apparatus, said system comprising:
a refrigerant storage tank; and
a sleeve, said sleeve being made of Linear Low Density Polyethylene and having a tubular shape and a predetermined size such that said sleeve is in removable fitting relation at least partially about circumference of said tank.

6. The system of claim 5 wherein said sleeve further comprising at least one writeable portion having a predetermined size.

7. The system of claim 5 wherein said sleeve further comprising a bar code.

8. A refrigerant storage tank labeling system having a removable labeling apparatus, said system comprising:
a refrigerant storage tank; and
a sleeve, said sleeve having an elongated shape and a predetermined size wherein said sleeve wraps around said tank and is attached to itself whereby said sleeve forms a tubular shape and is in removable fitting relation at least partially about circumference of said tank.

9. The system of claim 8 wherein said sleeve further comprising at least one writeable portion having a predetermined size.

10. The system of claim 8 wherein said sleeve further comprising a bar code.
